(19) United States
(12) Patent Application Publication
(10) Pub. No.: US 2013/0134098 A1
(43) Pub. Date: May 30, 2013

(54) WATER TREATMENT PROCESSES FOR NORM REMOVAL

(71) Applicants: William Leonard Kostedt, IV, Clifton Park, NY (US); James Manio Silva, Clifton Park, NY (US); Hope Matis, Schenectady, NY (US); Vicki Herzl Watkins, Alplaus, NY (US); Harish Radhakrishna Acharya, Clifton Park, NY (US)

(72) Inventors: William Leonard Kostedt, IV, Clifton Park, NY (US); James Manio Silva, Clifton Park, NY (US); Hope Matis, Schenectady, NY (US); Vicki Herzl Watkins, Alplaus, NY (US); Harish Radhakrishna Acharya, Clifton Park, NY (US)

(73) Assignee: GENERAL ELECTRIC COMPANY, Schenectady, NY (US)

(21) Appl. No.: 13/307,656

(22) Filed: Nov. 30, 2011

(51) Int. Cl. C02F 1/62; C01G 45/02; C02F 1/52; C02F 1/48; C02F 1/28

(52) U.S. Cl. 210/670; 210/682; 210/726; 423/605

(57) ABSTRACT

Methods for treating water to remove radium include contacting the water with a magnetic adsorbent comprising manganese oxide(s), and applying a magnetic field to separate the magnetic adsorbent from the water, whereby radium is removed from the water. The methods may additionally include regenerating the magnetic adsorbent, and contacting the water with regenerated magnetic adsorbent. Alternately, calcium and/or strontium may be precipitated as carbonate salts from lime-treated water containing radium and barium without precipitating a significant fraction of the barium or radium; and removing radium from calcium- and strontium-free water by precipitating the barium and radium as carbonate salts. The barium- and radium carbonate precipitate may be redissolved in hydrochloric acid and disposed of by deep-well injection.

### STATEMENT REGARDING FEDERALLY SPONSORED RESEARCH AND DEVELOPMENT

This invention was made with Government support under Subcontract 08122-36 to Research Partnership to Secure Energy for America (RPSEA), a contractor to the United States Department of Energy under prime contract DE-AC26-07NT42677. The Government has certain rights in the invention.

### BACKGROUND

Shale gas production in the US has increased from 0.3 TCF in 1996 to 4.8 TCF in 2010, accounting for 23% of the nation's natural gas supply. Water is used extensively in shale gas production. A typical well uses 4-5 million gallons of water for the drilling and hydrofracturing processes. During the first few weeks after hydrofracturing, about 10-40% of this water is returned to the surface as a brine solution termed “flowback” water. After the flowback period, each shale gas well continues to yield “produced” water at a modest rate (e.g. 7 barrels/day) for many years. Both flowback and produced water are often termed “frac water”. In the Marcellus shale gas play, about 90-95% of the frac water is currently reused in subsequent drilling and hydrofracturing activities. However, as the number of shale gas wells in a particular area continues to increase, the supply of produced water will exceed the demand for water for hydrofracturing. In some shale gas plays, such as the Barnett, frac water is disposed of by deep-well injection, (also referred to as saline water disposal or underground injection control (UIC)). In the Pennsylvania Marcellus, frac water disposal is severely limited because of the near absence of deep-well injection facilities. Thus, Pennsylvania Marcellus excess frac water must be trucked into Ohio for deep well injection, which is quite expensive. A desirable alternative is to economically recover frac water as distilled water and a solid salt product.

Frac waters from some Marcellus shale gas plays contain significant levels of Naturally Occurring Radioactive Materials (NORM), primarily as radium, in conjunction with very high salinity levels (50,000-200,000 ppm TDS) and high levels of hardness ions, including magnesium, calcium, strontium, and barium. Soluble barium is toxic; radium is carcinogenic. It is desirable to remove both species from frac water. Barium and radium are chemically quite similar; processes to remove radium from frac water also remove barium. In order to recover clean water and a substantially barium- and radium-free solid salt product, it is necessary to pretreat the frac water to remove both radium and barium. Traditional methods of removing radium and barium from brines utilize sulfate precipitation, which yields a mixture of radium sulfate and barium sulfate. The problem with this method is that the sulfate precipitate (sludge) from Marcellus frac waters contains excessive radium for safe disposal in non-hazardous landfills. To safely dispose of the radium-contaminated sulfate sludge would require disposal as Low Level Radioactive Waste (LLRW), which would be cost-prohibitive. For radium and barium disposal, it is much more cost effective to concentrate these species into an aqueous stream that may be deep-well injected. There remains a need for a cost-effective method for removing radium and barium from frac water as aqueous concentrates, which will enable economical water and solid salt recovery.

### BRIEF DESCRIPTION

In one aspect, the present invention relates to methods for treating water to remove radium. In the methods, water containing radium is contacted with a magnetic adsorbent comprising manganese oxide(s), and applying a magnetic field to separate the magnetic adsorbent from the water, whereby radium is removed from the water. The methods may additionally include regenerating the magnetic adsorbent, and contacting the water with regenerated magnetic adsorbent. In another aspect, the present invention relates to methods for regenerating a particulate manganese oxide adsorbent by treating the adsorbent with dilute acid to remove both radium and barium from the adsorbent.

In yet another aspect, the present invention relates to methods for treating water containing radium, including precipitating calcium and/or strontium as carbonate salts from lime-treated water without precipitating a significant fraction of the barium or radium; and removing radium from substantially calcium- and strontium-free water by precipitating the barium and radium as carbonate salts. The barium- and radium carbonate precipitate may be redissolved in hydrochloric acid and disposed of by deep-well injection.

### DETAILED DESCRIPTION

In the processes of the present invention, raw frac water is first treated with lime and air to precipitate iron, manganese, and magnesium. The iron, magnesium, and manganese, as well as suspended solids, may then be filtered from the frac water using, for example, a clarifier. The sludge from the lime treatment step typically does not contain a significant level of radioactivity, and may be sent to a sludge thickener for dewatering, followed by disposal in a suitable nonhazardous landfill. The clarified frac water stream may optionally be filtered before the next step.

The water may then be treated by either of two processes for radium and barium removal. In the first process, frac water is contacted with a magnetic adsorbent comprising manganese oxide(s). Radium and barium are adsorbed on the material and the magnetic adsorbent is separated from the water by applying a magnetic field gradient.

Magnetic adsorbents for use in the methods of the present invention are particulate in nature and comprise manganese oxide and a magnetic material. In the context of the present invention, the terms “manganese oxide” and “MnOx” refer to a single oxide of manganese, typically manganese dioxide, MnO₂, or to a mixture of oxides. The oxides of the mixture may include manganese (IV) dioxide, MnO₂, manganese (II) oxide, MnO, manganese (II,III) oxide, Mn₃O₄ manganese (III) oxide, Mn₂O₃, and manganese (VII) oxide, Mn₂O_{7.} In many embodiments, manganese dioxide is a primary component of the mixture.

The magnetic material may be selected from metals, including iron, nickel, chromium, gadolinium, neodymium, dysprosium, samarium, erbium, and their alloys, and magnetic compounds, including iron carbides, iron nitrides and iron oxides. Iron oxides are particularly suitable materials and include iron (II) oxide (FeO), iron (II,III) oxide (Fe₃O₄), and iron (III) oxide (Fe₂O₃). Specific examples include magnetite (iron (II,III) oxide), maghemite (iron (III) oxide, γ-Fe₂O₃), and hematite (iron (III) oxide, α-Fe₂O₃). In particular, the magnetic material may comprise or be derived from magnetite.

The molar ratio of iron to manganese in the magnetic adsorbent is not limited to any particular range as long as the response of the adsorbent to a magnetic field is strong enough to effect a separation between the adsorbent and the treated frac water stream. In particular embodiments, the ratio ranges from about 10:1 to about 1:1, particularly from about 5:1 to about 1:1. In some embodiments, the molar ratio of iron to manganese is about 1:1. In some cases, magnetic adsorbents having a larger particle size may have magnetic properties that are more favorable for separation and may be composed of a material having a lower ratio of Fe:Mn.

The manganese oxide magnetic adsorbent may be prepared by synthesizing manganese oxide in the presence of magnetic particles. Methods for synthesizing manganese oxide are known in the art; see, for example, Rosas, C. A. C., Synthesis and Application of Manganese Dioxide Coated Magnetite for Removal of Metal Ions from Aqueous Solutions, http://books.google.com/books?id=5Dm7YgEACAAJ, (2010). One suitable method is to combine MnCl₂ with KMnO₄ at high pH, according to equation 1. In a particular embodiment, the magnetic particles are composed of magnetite.

3Mn(II)Cl₂+2KMn(VII)O₄+2H₂O→5Mn(IV)O₂+2KCl+4HCl (1)

The resulting magnetic adsorbent is desirably used as an aqueous slurry without isolating the product as a solid.

The magnetic adsorbent may be contained within a vessel while water is passed through it, and/or may be separated from treated water by applying a magnetic field. Various configurations for containing or separating the adsorbent may be used. Non-limiting examples of suitable configurations are described in U.S. Pat. No. 4,247,398, U.S. Pat. No. 7,371,327, U.S. Pat. No. 7,785,474, and U.S. Pat. No. 7,938,969.

The magnetic adsorbent may be regenerated using an aqueous acid solution and reused. The pH of a slurry containing the magnetic adsorbent is adjusted until the net surface charge of the adsorbent particles is about zero. ‘Net surface charge of zero’ means that there are an equal number of positively and negatively charged surface sites. In many embodiments, the pH of the slurry is adjusted to about pH 2. Any organic or inorganic acid, or mixtures thereof, may be used for the pH adjustment. For example, hydrochloric acid may be used. Sulfuric acid is not recommended because of the possibility of precipitating barium sulfate and radium sulfate. The amount of HCl used for regeneration ranges from about 0.05 millimole HCl per gram of the manganese oxide adsorbent to about 50 mmol HCl per gram of the manganese oxide adsorbent, particularly from about 0.08 millimole HCl per gram of the manganese oxide adsorbent to about 10 mmol HCl per gram of the manganese oxide adsorbent. Concentration of the acid is not critical, but it may be desirable to use a dilute solution, for example, 0.1N or 0.01N. Regeneration of non-magnetic MnOx adsorbents may also be effected by pH adjustment to a net surface charge of about zero.

After radium and barium removal, the frac water may be treated with sodium sulfate in a clarifier to coprecipitate residual radium and barium as RaSO₄ and BaSO₄. Because the bulk of the radium is removed from the frac water prior to sulfate treatment, the radium level in the sulfate sludge may be acceptable for disposal in a RCRA-D landfill for non-hazardous waste. The sulfate sludge may be dewatered in a thickener and filter press.

An alternate method for pretreating frac water for water and salt recovery is to utilize a three-step precipitation/redissolution process to selectively precipitate barium and radium as carbonates. This carbonate mixture may be separated from the frac water, redissolved using acid, and disposed of by deep well injection. This process results in essentially complete softening of the frac water, which enables high water and salt recovery. The first step in this process, after lime treatment to precipitate magnesium, manganese, and iron, is to introduce sufficient carbonate ion to the frac water to precipitate calcium and strontium, which are the least soluble carbonate species. Suitable sources of carbonate ion include, but are not limited to, carbon dioxide and carbonate salts such as sodium carbonate and potassium carbonate, and mixtures thereof. Where carbon dioxide is used as a source of carbonate ion, it may be sparged into the frac water. Operating parameters are adjusted so that the solid product is substantially free of barium carbonate and radium carbonate. For example, the agitation power per unit volume of solution, the feed carbonate concentration, and the rate of addition may be adjusted to maximize the selectivity of this process in favor of calcium and strontium carbonate precipitation. The solid products of this carbonate treatment are typically barium- and radium-free, and may be disposed of in a non-hazardous landfill. In the second step, radium and barium may then be coprecipitated as a mixed barium carbonate-radium carbonate solid by adding sodium carbonate or another carbonate source. The carbonate solids from this step may be separated from the water (which is now substantially radium- and barium-free), and redissolved by treatment with concentrated HCl to form a concentrated solution of BaCl₂ and RaCl₂. This aqueous barium and radium concentrate may be disposed of by deep-well injection. In some cases, it may be desirable to adjust the pH of the redissolved barium- and radium-containing solution in order to comply with regulations governing and other requirements for transportation or deep-well injection of the materials. A pH of about 7 is typically desirable.

If desired, the radium-free water from either radium and barium removal pretreatment process may be passed through a thermal evaporator or an equivalent, such as a brine concentrator, to preconcentrate the brine. Brine concentration technology is well established and one of skill in the art would be able to configure and operate a system for use with frac water brine without difficulty. For example, vertical-tube, falling-film evaporators may be used in this step, such as the RCC® Brine Concentrator, available from GE Water & Process Technologies, which is a type of falling film evaporator. Alternatively, a mobile, forced circulation evaporator may be used to concentrate the softened frac water and recover a distilled water product.

The preconcentrated brine may then be passed through a salt crystallizer to recover distilled water and salable NaCl. Any crystallizer for use with concentrated brine may be used. RCC® Crystallizer systems from GE Water & Process Technologies are particularly suitable, which utilize mechanical vapor recompression (MVR) technology to recycle the steam vapor, minimizing energy consumption and costs.

In a final, optional, step, the salt produced in the crystallizer may be washed to yield a material that may be sold for use as road salt. Even without a wash step, in some cases, the dry crystalline NaCl product may meet government standards for use as road salt, being free of toxic substances as determined by Toxicity Characteristic Leaching Protocol (TCLP) analysis and conforming to the ASTM D-635 standard for road salt. The wash water may be recycled to the frac water pretreatment process or subjected to lime treatment to produce a sludge that may be dried prior to disposal as non-hazardous waste.

### EXAMPLES

### Example 1

### Synthesis of MnOx Magnetic Adsorbent

Magnetite (iron (II,III) oxide), 97% (metals basis), particle size 325 mesh from Alfa Aesar was used as received for the magnetic component. Potassium hydroxide, potassium permanganate and manganese chloride solutions were prepared (56.1 g/L KOH, 31.6 g/L KMnO₄ and 198 g/L MnCl₂*4H₂O) using reagent grade solids and 18.2 MΩ-cm deionized (DI) water. The KMnO₄ solution (460 mL) was added to a 4 L Erlenmeyer flask, diluted to about 3 L with DI water and stirred with a magnetic stir bar. 280 mL of KOH was added and the pH was verified to be >12 with pH paper. Then 70 mL of MnCl₂*4H₂O was added in 5 mL increments while stirring. A brown precipitate formed and 20 g of Fe3O4 powder was added and mixed into solution. Then another 70 mL of MnCl₂*4H₂O was added in 5 mL increments under continued stirring. Once added, the mixture was allowed to stir for 30 minutes. Adding the magnetite after some of the permanganate had reacted appeared to help the magnetite retain its magnetic properties. After 30 minutes an aliquot was placed in a centrifuge tube with an adjacent magnet to verify that the composite was magnetic and that there were no free MnOx particles visible (the solution turned clear). The magnetic stir bar was removed and the particles were allowed to settle for 30 minutes while pipetting off the clear water in 100 mL quantities until about 2 L remained. The particle concentration was found to be 28.8 mg/mL by pipetting 20 mL into three aluminum drying dishes and drying until the weight was constant. The magnetic adsorbent was used as a slurry for all experiments.

### Example 2

### Comparison Between Magnetic Adsorbent of Example 1 and Commercially Available MnFe₂O₄

Nano manganese ferrite (MnFe₂O₄) powder, 99.9%, particle size 20-50 nm was obtained from Inframat, Product #26F25-ON1. The radium removal capacity of the Inframat material and the adsorbent of Example 1 were determined using Well-4 frac water. The composition of the frac water is shown in Table 1. The concentrations of species other than radium were measured by ICP (Inductively Coupled Plasma). The radium concentration was measured by gamma spectrometry.

TABLE 1
Composition of Well-4 Frac Water
all quantities ppm (mg/L) except for ²²⁶Ra, pCi/liter

| | |
|---|---|
| TDS | 68,439 |
| Na | 19,200 |
| Mg | 570 |
| Ca | 5,360 |
| Sr | 1,290 |
| Ba | 32 |
| Fe | 55 |
| Mn | 1.7 |
| Cl | 41,845 |
| SO₄ | 57 |
| SiO₂ | 29 |
| ²²⁶Ra | 4,600 |

MnFe₂O₄ was added to 7 centrifuge tubes in amounts varying from about 10 mg to 1.2 g and mixed with 15-17 gm frac water. The magnetic adsorbent of Example 1 was added to 7 centrifuge tubes in amounts varying from about 0.3 mg to 30 mg and mixed with 15-17 gm frac water. The centrifuge tubes were placed on a rotator to mix for 24 hours. The rotator was operated at 22 RPM. After 24 hours the tubes were removed, and allowed to settle for 5 minutes. An aliquot was removed from each treated sample. This aliquot was filtered with a 0.45 um syringe filter and transferred to a vial for liquid scintillation counting (LSC) to measure the radium concentration. LSC correlates well to a more traditional measurement technique like a high purity germanium detector (HPGe) for gamma spectrometry. The estimated radium activity in treated samples is based on the measured radium in the untreated (feed) sample and LSC measurements (counts per minute) of a given sample less the background (counts per minute) sample, which contains no radium, as shown in the equation below.

$${}^{226} Ra Activity \frac{pCi}{L} = {[ {}^{226} Ra ]}_{treated} = {[ {}^{226} Ra ]}_{{untreated}_{( gamma \text{-} spec )}} \frac{{( cpm - {cpm}_{bkgd} )}_{treated}}{{( cpm - {cpm}_{bkgd} )}_{untreated}}$$

The vials were counted twice 25 days apart. The final count is the most relevant because it allowed the radium and daughters to reach secular equilibrium. The Inframat MnFe₂O₄ material of Example 2 had a maximum capacity of about 1000 pCi/g. The adsorbent of Example 1 had a capacity of about 28,000 pCi/g. These capacities are calculated from the following equation.

$${}^{226} Ra capacity \frac{pCi}{gm resin} = ( \frac{{[ {}^{226} Ra ]}_{untreated} - {[ {}^{226} Ra ]}_{treated} \frac{pCi}{Lbrine}}{x gm resin} ) ( \frac{y mL frac water}{1000 \frac{mL}{L}} )$$

### Example 3

### Impact of Ba and Na on Radium Adsorption

The adsorbent of Example 1 was added to Well-4 water in centrifuge tubes that were rotated at 22 RPM for 24 hours. Barium was added as barium chloride at concentrations ranging from 0 to 11 g/L with and without 8% sodium chloride for a total of 8 conditions. Samples were analyzed using LSC as described above. The effect of barium was associated with a decrease in radium capacity. At about 4 g/L Ba2+, which is within the normal range for frac water from the Marcellus Shale formation, the radium capacity of the adsorbent was about 3000 pCi/L. The ultimate capacity is likely to be higher because the isotherms were all performed at about 3 mg adsorbent per centrifuge tube, which for Example 1 (no added barium) was about half of the ultimate capacity. The capacity varied with concentration of the sorbent because the driving force (concentration gradient between the dissolved radium and the sorbent surface) is greater when the concentration of sorbent is lower. Sodium level had little effect on radium capacity.

### Example 4

### Magnetic Column Study

A magnetic column unit from Cross Technologies was used to generate a magnetic field gradient within a column that confines particles, but allows them to remain distributed enough to maintain their radium removal capacity and pass water through the column. The Cross Technologies unit was powered by a DC power supply. For the initial loading experiment, approximately 2.37 g of the magnetic adsorbent of Example 1 was loaded on to the column by energizing the coil with 1.5 A of current. The unit was rinsed at a high velocity and an additional 16.7 g of MnFe₂O₄ was loaded on the column for a second experiment. Samples (10 mL) were taken each minute for LSC and total solids (TS) analysis. The rest of the flow was collected in 500 mL increments to analyze with HPGe.

For total solids analysis, 2 mL of sample was dried on an aluminum drying dish, heated to 110 C and weighed until it reached a constant weight. The solids concentration was calculated by dividing the dry mass by the volume added. This provided a breakthrough curve for the frac water, which had to first displace the DI water initially in the column.

For both experiments, radium remained below the feed concentration for the entire study. With the increase in sorbent loading from 2.37 g to 16.7 g, there was a corresponding increase in total radium removal. The LSC data and HPGe data showed the same trends for each experiment. Total solids data indicate that the effluent solids concentration was nearly equal to the influent concentration at about 10 minutes while radium continued to be removed. By estimating the total radium removal and correcting for DI water that was initially in the column, it was possible to calculate the loading of the sorbent and compare to the batch isotherm data collected previously. For the 2.37 g experiment, the final radium loading on the adsorbent was estimated to be about 980 pCi/L, whereas the loading was estimated to be 402 pCi/g for the 16.7 g experiment. The batch isotherm indicated a capacity of about 1000 pCi/g. The loading in the column was lower than the batch isotherm, but it was much greater than what would be expected if the adsorbent particles were aggregated into a small clump.

### Example 5

### Radium Removal Capacity

Multi-point isotherm experiments were conducted for solid sorbents: the adsorbent of Example 1, Dowex™ RSC resin, and the Inframat nano manganese ferrite of Example 2. The sorbents were mixed with Well-4 frac water containing about 4600 pCi/L of radium-226 in 15 mL centrifuge tubes in a range of concentrations with at least 4 points per material. The centrifuge tubes were placed on a rotator and allowed to spin at 22 RPM for at least 4 hours at 22±3 C. The samples were removed from the rotator, allowed to settle for 15 minutes, and then about 3 mL was removed with a syringe and filtered through a 0.45 μm PTFE filter. A 1 mL aliquot was transferred to a scintillation vial and mixed with scintillation cocktail. The sample was analyzed with a liquid scintillation counter and a previously developed correlation was used to determine the radium-226 concentration after the sample was allowed to reach secular equilibrium. The concentration change from a control sample was used to determine the loading in pCi removed per gram of sorbent. The highest removal capacity, which typically corresponded to the lowest concentration of sorbent, is shown in the table below.

TABLE 2A

| | | | Sorbent Radium |
|---|---|---|---|
| | estimated [Ra]_{treated} | % Ra removal | removal capacity, |
| Sorbent | pCi/L | from frac water | pCi/g |
| DOWEX RSC | 2455 | 43 | 640 |
| Nano manganese | 3936 | 15 | 1000 |
| ferrite | | | |
| PNNL proprietary | 1076 | 81 | 3900 |
| sorbent | | | |
| Example 1 | 4157 | 11 | 28000 |

Ra-226 content in the various sorbents ranged from 640 pCi/g to 28000 pCi/g. The Dowex RSC is a resin designed to remove radium from water, but its capacity may have been reduced by competition with other cations. Nano-MnFe₂O₄ is not specifically designed for radium removal, but its radium removal capacity is higher than that of Dowex RSC. A proprietary sorbent synthesized at Pacific Northwest National Laboratories (PNNL) had a capacity of 3900 pCi/g. The Fe3O4-MnO2 material had the highest capacity of those explored at 28000 pCi/g. The higher capacity of this material may result in lower frac water treatment costs including the initial cost, regeneration and disposal costs. Although barium measurements were not made for these tests, it is expected that each sorbent also resulted in percentage reductions of barium that are comparable to the percentage reductions observed for radium.

### Example 6

### Radium Removal Capacity in the Presence of Barium

The procedure of Example 5 was used with Well-4 frac water, spiked with a quantity of BaCl₂ sufficient to result in a concentration in the water corresponding to 1000-11,600 ppm Ba⁺². The capacity data was interpolated so that all reported values corresponded to 5000 mg/L Ba²⁺. The formula for interpolation was:

$${Cap}_{5000 ppmBa} = {Cap}_{X 1} + \frac{( 5000 - X 1 )}{( X 2 - X 1 )} ( {Cap}_{X 2} - {Cap}_{X 1} )$$

Where the measured capacities at X1 ppm Ba⁺² and X2 ppm Ba⁺² are Cap_{X1} and Cap_{X2}, respectively, and X1<5000<X2.

| Material | Ra⁺² Capacity, pCi/g at 5,000 ppm Ba⁺² |
|---|---|
| Dowex RSC | 89 |
| Proprietary Resin | 469 |
| Example 1 | 2853 |

The results show that the capacity of the magnetic adsorbent of Example 1 was six times greater than the next most effective adsorbent, the proprietary resin, and 32 times greater than the Dowex RSC resin.

### Example 7

Manganese oxide adsorbent was exposed to Well-4 frac water as follows. Approximately 0.5 gm of commercially available Fluka activated MnO2 was placed in a 50 mL centrifuge tube. To this tube, 40 mL of Well-4 frac water was added and placed on an orbital shaker for four hours at 200 rpm. The initial frac water was measured by Liquid Scintillation Counting (LSC) to have 51.18 cpm above background, which corresponds to 4285 pCi/L ²²⁶Ra, as shown in the equation.

$$[ {}^{226} Ra ] \frac{pCi}{L} = ( x - bkgnd \frac{count}{min} ) ( \frac{pCi {}^{226} Ra}{\frac{13.32 decomp}{min}} ) ( \frac{\frac{decomp}{min}}{0.9 \frac{count}{min}} ) ( \frac{1000 \frac{mL}{L}}{y mL sample} )$$

All samples (for all examples) were allowed to equilibrate for at least two weeks before being measured by LSC. The ²²⁶Ra activity of frac water was independently measured using gamma spectrometry to be 4600±590 pCi/L. For the purpose of these examples, the ²²⁶Ra activity of the frac water is taken to be 4285 pCi/L. Thus, 40 mL of this solution contains 171 pCi ²²⁶Ra. After shaking, the sample was centrifuged at 2100 rpm for 10 minutes. The supernatant was decanted from the MnOx adsorbent and the supernatant was analyzed by LSC to have a ²²⁶Ra activity of 17 pCi ²²⁶Ra. Thus, 154 pCi of ²²⁶Ra was adsorbed by the MnOx. The supernatant was decanted and set aside. The MnOx was rinsed with 40 mL deionized water and then centrifuged at 2100 rpm for 10 minutes. The deionized water showed negligible ²²⁶Ra activity.

The MnOx adsorbent was regenerated as follows. Ten mL 0.01N HCl was added to the centrifuge tube containing the rinsed MnOx adsorbent from the exposure step described in Example 7. This mixture was shaken for 1 hour at 200 rpm on an orbital shaker. After shaking, the sample was centrifuged at 2100 rpm for 10 minutes. The supernatant was decanted and analyzed by LSC to have 1.2 pCi ²²⁶Ra. The MnOx was rinsed with 40 mL of DI water and centrifuged at 2100 rpm for 10 minutes after which the rinse was discarded. The combination of an exposure and a regeneration constitutes a cycle. The MnOx was subjected to four complete exposure-regeneration cycles followed by an exposure. Table 2B shows the amount of ²²⁶Ra adsorbed from the frac water onto the MnOx and the amount of ²²⁶Ra removed from the MnOx by the regenerant (0.01N HCl) for each exposure and regeneration, respectively. Table 2B shows that the amount of ²²⁶Ra adsorbed decreased in each successive cycle, and that the amount of ²²⁶Ra removed by the 0.01N HCl was negligible in each cycle. Thus, 0.01N HCl is not an effective regenerant.

### Example 8

Example 7 was repeated using 0.1N HCl as a regenerant. Table 2B shows that by using 0.1N HCl rather than 0.01N HCl as a regenerant, the amount of ²²⁶Ra adsorbed by the MnOx was much more consistent in successive cycles. In addition, the amount of ²²⁶Ra removed with 0.1N HCl was significantly higher than the amount removed with 0.01N HCl.

### Example 9

Example 7 was repeated, except that 1N HCl was used as a regenerant. Table 2B shows that compared with using 0.01N HCl as a regenerant, 1N HCl removes more ²²⁶Ra from the adsorbent. However, regeneration with 1.0N HCl enables only a slight increase in the adsorption performance of MnO₂ on subsequent cycles compared to regeneration with 0.1N HCl.

TABLE 2B

| | Example 7 | | Example 8 | | Example 9 | |
|---|---|---|---|---|---|---|
| | pCi | pCi ²²⁶Ra | pCi | pCi ²²⁶Ra | | pCi ²²⁶Ra |
| | ²²⁶Ra | Removed | ²²⁶Ra | Removed | | Removed |
| | Ad- | from | Ad- | from | pCi ²²⁶Ra | from |
| | sorbed | MnOx | sorbed | MnOx | Adsorbed | MnOx |
| | onto | (0.01N | onto | (0.1N | onto | (1.0N |
| Cycle | MnOx | HCl) | MnOx | HCl) | MnOx | HCl) |
| 1 | 154 | 1.18 | 156 | 66 | 160 | 110 |
| 2 | 141 | 1.87 | 138 | 81 | 153 | 140 |
| 3 | 138 | 0.83 | 149 | 105 | 161 | 149 |
| 4 | 120 | 2.06 | 150 | 130 | 151 | 149 |
| 5 | 116 | | 158 | | 162 | |

### Example 10

Fifteen mg of a proprietary MnOx adsorbent were added to a centrifuge tube and mixed with 15 mL of the Well-4 frac water. This mixture was mounted on a rotator and agitated at 22 RPM for one hour. The mixture was allowed to settle for one hour after which the supernatant liquid was removed and filtered through a 0.45 micron syringe filter. The filtered liquid was analyzed by LSC for ²²⁶Ra activity as described in Example 2. As shown in Table 3A, the initial (untreated) frac water ²²⁶Ra activity was 64 pCi. After treatment, the frac water ²²⁶Ra activity was 15 pCi. Thus, 48.5 pCi ²²⁶Ra were adsorbed onto the MnOx, which is 76% of the ²²⁶Ra in the feed frac water. In addition, the treated frac water had 14.9 mg/L barium. Thus, the MnO2 adsorbed 53% of the barium in the frac water. Table 3B shows that the MnO2 adsorbed 17.1 mg barium per gram of sorbent. The MnO2 adsorbent is effective for both radium and barium removal from frac water.

The adsorbent was then regenerated by adding 15 mL of 0.1N HCl to the centrifuge tube containing the spent adsorbent from the first exposure cycle, and agitating using the rotator for 1 hour. The centrifuge tube was removed from the rotator and the contents were allowed to settle for 1 hour. After settling, the regeneration solution was removed from the adsorbent for LSC analysis, after which the adsorbent was rinsed with approximately 15 mL of DI H₂O and sufficient NaHCO3 to obtain a neutral pH by pH paper. As shown in Table 3A, the ²²⁶Ra activity in the regeneration solution was 27 pCi. Thus, about 55% of the ²²⁶Ra removed from the frac water during the first exposure cycle was removed from the adsorbent by this regeneration process. In addition, the regeneration solution contained 14.5 mg/L barium. Thus, about 85% of the barium that adsorbed onto the MnO2 was removed by treatment with 0.1N HCl. These results show that 0.1N HCl is effective for removing both radium and barium from MnO2. Table 3B shows that with 0.1N HCl treatment, 14.5 mg barium are removed from the adsorbent per gm adsorbent.

To test the performance of the regenerated MnOx, a second 15 mL batch of Well-4 frac water was added to the vial containing the regenerated MnOx adsorbent. The agitation was the same as during the first exposure. After settling, the supernatant was removed from the centrifuge tube and filtered through a 0.45 micron filter and analyzed by LSC. Table 3A shows that the regenerated MnOx adsorbent removed 52 pCi ²²⁶Ra during the second exposure (compared with 48.5 pCi during the first exposure). In addition, during this second exposure, the MnO2 adsorbent removed 23.6 mg barium per gram adsorbent (compared with 17.1 mg/g during the first exposure).

### Example 11

Example 10 was repeated with 15 mg of another proprietary MnOx adsorbent. In this example, the adsorbent was exposed to the Well-4 frac water and then regenerated as before with 0.1N HCl. The results are presented in Table 3A and 3B. The regeneration removed 21 pCi ²²⁶Ra from the adsorbent. As in example 10, the Mn02 adsorbent removed barium as well as radium from the frac water. Both barium and radium were regenerated from the adsorbent with 0.1N HCl.

### Example 12

Example 10 was repeated, but instead of 0.1N HCl, DI water was used as a regenerant. This example shows that DI water does not remove ²²⁶Ra from the adsorbent and that the adsorbent does not remove as much ²²⁶Ra during the second cycle (43 pCi) as during the first cycle (50 pCi). The details of this example are shown in Table 3A and Table 3B. Further, the regeneration removed only 2.5 pCi of radium and only 1.4 mg barium per gm adsorbent. Thus, DI water is not effective for regeneration of the adsorbent.

TABLE 3A

| | Example 10 | | Example 11 | | Example 12 | |
|---|---|---|---|---|---|---|
| | pCi | pCi ²²⁶Ra | pCi | pCi ²²⁶Ra | | pCi ²²⁶Ra |
| | ²²⁶Ra | Removed | ²²⁶Ra | Removed | | Removed |
| | Ad- | from | Ad- | from | pCi ²²⁶Ra | from |
| | sorbed | MnOx | sorbed | MnOx | Adsorbed | MnOx |
| | onto | (0.01N | onto | (0.1N | onto | (DI |
| Cycle | MnOx | HCl) | MnOx | HCl) | MnOx | Water) |
| 1 | 48.5 | 27 | 52 | 21 | 50 | 2.5 |
| 2 | 52 | — | — | — | 43 | — |

TABLE 3B

| | Example 10 | | | | | |
|---|---|---|---|---|---|---|
| | | mg Ba | Example 11 | | Example 12 | |
| | mg Ba | Removed | mg Ba | mg Ba | mg Ba | mg Ba |
| | ad- | per gm | ad- | Removed | ad- | Removed |
| | sorbed | sorbent | sorbed | per gm | sorbed | per gm |
| | per gm | (0.1N | per gm | sorbent | per gm | sorbent |
| Cycle | sorbent | HCl) | sorbent | (0.1N HCl) | sorbent | (DI H2O) |
| 1 | 17.1 | 14.5 | 17.5 | 13.0 | 17.0 | 1.40 |
| 2 | 23.6 | — | — | — | 12.2 | — |

The feed compositions of the Marcellus frac waters used in Examples 13 and 14 are shown in Table 4.

TABLE 4
Marcellus Frac Water Feed Composition
(all values refer to ppm mg/L except where indicated)

| Component | Well-5 Examples 13, 14 |
|---|---|
| TDS | 149,188 |
| Na⁺ | 39,000 |
| Mg⁺⁺ | 1,000 |
| Ca⁺⁺ | 13,000 |
| Sr⁺⁺ | 2,600 |
| Ba⁺⁺ | 3,500 |
| Fe⁺⁺ | 32 |
| Mn⁺⁺ | 2.7 |
| Cl⁻ | 90,014 |
| SO₄⁼ | <5 |
| ²²⁶Ra^{*} pCi/L | 5,600 |

### Example 13

One liter of Well-5 frac water was added to a 2-liter beaker, which was placed on a stir plate under ambient conditions. The solution was agitated using a magnetic stir bar. The initial pH of this solution was 5.9. To this solution, 37.35 gm 10 wt % Ca(OH)2 was added, which increased the pH to 10.62, and precipitated the magnesium as Mg(OH)2. Then, 424.9 gm of 10 wt % Na₂CO₃ solution was added to this agitated mixture over the course of 316 minutes at a constant feed rate. Samples of the supernatant were removed periodically, filtered through 0.45 micron filters, and the residual radioactivity of these samples was measured by liquid scintillation counting.

Table 5 shows the results from this test. The supernatant retained a large fraction of the feed radioactive content as sodium carbonate was added to the system. Thus after adding enough Na₂CO₃ to precipitate all of the Ca and Sr (348 gm Na₂CO₃ solution), 66% of the radioactive content in feed was still in the supernatant, which shows a significant selectivity toward precipitation of non-radioactive species (over radioactive species). At about the stoichiometric point for complete Ca and Sr precipitation (i.e. moles Na₂CO₃ added=moles Ca+Sr in feed) the precipitate was removed. On further addition of Na₂CO₃, additional precipitate was substantially BaCO3 and RaCO3.

TABLE 5
Results for Example 13

| Mass | Mole | Mole | Fraction |
|---|---|---|---|
| Na2CO3 (g) | Na2CO3 | Na2CO3 | feed |
| solution | per mole | per mole | radioactivity |
| added | Ca + Sr + Ba | Ca + Sr | remaining |
| 0 | 0.000 | 0.000 | 1.00 |
| 20 | 0.054 | 0.060 | 0.90 |
| 45.46 | 0.122 | 0.137 | 0.80 |
| 89.67 | 0.241 | 0.270 | 0.86 |
| 120.52 | 0.324 | 0.363 | 0.79 |
| 201.01 | 0.541 | 0.605 | 0.80 |
| 300.58 | 0.809 | 0.905 | 0.64 |
| 322.08 | 0.867 | 0.970 | 0.76 |
| 335.55 | 0.903 | 1.011 | 0.59 |
| 348.97 | 0.940 | 1.051 | 0.66 |
| 389.34 | 1.048 | 1.173 | 0.63 |
| 403.63 | 1.087 | 1.216 | 0.57 |
| 424.9 | 1.144 | 1.280 | 0.37 |

### Example 14 (Comparative Example)

One liter of Well-5 frac water was placed in a glass beaker on a stir plate, and a magnetic stir bar was placed in the beaker. To this beaker, 43.29 g 10% CaOH2 solution added to bring pH from 5.68 to 10.92. Then, 212.92 g 20% Na2CO3 solution was added in 10 mL increments. Approximately two minutes elapsed between Na2CO3 additions. A sample was withdrawn from the beaker after every other Na2CO3 addition for analysis by LSC. Table 7 shows that the radioactivity remaining in solution decreased substantially proportionally to the addition of Na2CO3. For example, after 1.02 mole carbonate per mole calcium plus strontium had been added, which is sufficient to precipitate the calcium and strontium, there was only 25% of the radium left in solution. Thus, 75% of the radium precipitated during the interval in which only calcium and strontium should have precipitated. This example shows that with relatively rapid addition of Na2CO3 aliquots (rather than a slow, steady addition), there is significantly less selectivity toward calcium and strontium precipitation, which is unfavorable.

TABLE 7
(Example 15)

| | | fraction feed |
|---|---|---|
| | | radioactivity |
| mole Na₂CO₃ added per mole | Mole Na2CO3 added | remaining |
| Ca + Sr + Ba | per mole Ca + Sr | in solution |
| 0 | | 1 |
| 0.11 | 0.113 | 0.77 |
| 0.21 | 0.227 | 0.93 |
| 0.32 | 0.340 | 0.76 |
| 0.42 | 0.454 | 0.65 |
| 0.53 | 0.567 | 0.63 |
| 0.64 | 0.681 | 0.38 |
| 0.74 | 0.794 | 0.38 |
| 0.85 | 0.908 | 0.42 |
| 0.95 | 1.021 | 0.25 |
| 1.06 | 1.135 | 0.24 |

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for treating water to remove radium, said method comprising
contacting water containing radium with a magnetic adsorbent comprising manganese oxide(s); and
applying a magnetic field to separate the magnetic adsorbent from the water;
whereby radium is removed from the water.

2. A method according to claim 1, wherein the radium is selectively removed in the presence of at least 30 ppm barium.

3. A method according to claim 1, additionally comprising regenerating the magnetic adsorbent.

4. A method according to claim 1, comprising contacting the water with regenerated magnetic adsorbent.

5. A method according to claim 1, wherein the manganese oxide magnetic adsorbent comprises oxides of manganese and iron.

6. A method according to claim 1, wherein molar ratio of iron to manganese in the magnetic adsorbent ranges from about 10:1 to about 2:1.

7. A method according to claim 1, wherein molar ratio of manganese to iron in the magnetic adsorbent is about 3:1.

8. A method according to claim 5, wherein iron of the manganese oxide magnetic adsorbent is derived from magnetite.

9. A method according to claim 1, wherein the manganese oxide magnetic adsorbent comprises magnesium oxide(s) precipitated in the presence of magnetic particles.

10. A method according to claim 9, wherein the magnetic particles comprise magnetite.

11. A method for regenerating a particulate manganese oxide adsorbent by treating the adsorbent with dilute hydrochloric acid to remove both radium and barium from the adsorbent.

12. A method according to claim 11, wherein pH of the slurry is adjusted to pH of about 2.

13. A method according to claim 11, wherein the amount of HCl used for regeneration ranges from about 0.05 millimole HCl per gram of the manganese oxide adsorbent to about 50 mmol HCl per gram of the manganese oxide adsorbent.

14. A method according to claim 11, wherein the amount of HCl used for regeneration is in the range of from about 0.08 millimole HCl per gram of the manganese oxide adsorbent to about 10 mmol HCl per gram of the manganese oxide adsorbent.

15. A method for treating water containing radium, said method comprising
precipitating calcium and/or strontium as carbonate salts from lime-treated water without precipitating a significant fraction of the barium or radium; and
removing radium from calcium- and strontium-free water by precipitating the barium and radium as carbonate salts.

16. A method according to claim 15, wherein the barium- and radium carbonate precipitate is redissolved by acid treatment and disposed of by deep-well injection.

17. A method according to claim 15, wherein the barium- and radium carbonate precipitate is redissolved in hydrochloric acid and disposed of by deep-well injection.
